(19) United States
(12) Patent Application Publication
(10) Pub. No.: US 2025/0039670 A1
(43) Pub. Date: Jan. 30, 2025

(54) ACKNOWLEDGMENT PROTOCOL PROTECTION

(71) Applicants: Po-Kai HUANG, San Jose, CA (US); Danny ALEXANDER, Neve Efraim Monoson (IL); Ido OUZIELI, Tel Aviv (IL); Daniel BRAVO, Portland, OR (US)

(72) Inventors: Po-Kai HUANG, San Jose, CA (US); Danny ALEXANDER, Neve Efraim Monoson (IL); Ido OUZIELI, Tel Aviv (IL); Daniel BRAVO, Portland, OR (US)

(73) Assignee: Intel Corporation, Santa Clara, CA (US)

(21) Appl. No.: 18/401,043

(22) Filed: Dec. 29, 2023

Related U.S. Application Data
(60) Provisional application No. 63/502,011, filed on May 12, 2023.

(51) Int. Cl. H04W 12/106; H04L 5/00; H04W 12/043

(52) U.S. Cl. CPC H04W 12/106; H04L 5/0053; H04W 12/043

(57) ABSTRACT

This disclosure describes systems, methods, and devices related to enhanced wireless frame security. A device may utilize a Galois Message Authentication Code with a 256-bit key (GMAC-256) as an integrity protocol for block acknowledgment (BA) and block acknowledgment request (BAR). The device may generate a packet number (PN) and Message Integrity Code (MIC) using GMAC-256 for integrity design in the BA and BAR. The device may include a key identification (ID) indication in a BA control or BAR control field for the BA and BAR. The device may

### CROSS-REFERENCE TO RELATED APPLICATION(S)

This application claims the benefit of U.S. Provisional Application No. 63/502,011, filed May 12, 2023, the disclosure of which is incorporated herein by reference as if set forth in full.

### TECHNICAL FIELD

This disclosure generally relates to systems and methods for wireless communications and, more particularly, to acknowledgment protocol protection.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

FIG. 1 is a network diagram illustrating an example network environment for enhanced wireless frame security, in accordance with one or more example embodiments of the present disclosure.

FIGS. 2A-2B depict illustrative schematic diagrams for enhanced wireless frame security, in accordance with one or more example embodiments of the present disclosure.

FIGS. 3A-3C depict illustrative schematic diagrams for enhanced wireless frame security, in accordance with one or more example embodiments of the present disclosure.

FIGS. 4A-4B depict illustrative schematic diagrams for enhanced wireless frame security, in accordance with one or more example embodiments of the present disclosure.

FIGS. 5A-5B and 6A-6D depict illustrative schematic diagrams for enhanced wireless frame security, in accordance with one or more example embodiments of the present disclosure.

FIGS. 7 and 8 depict illustrative schematic diagrams for enhanced wireless frame security, in accordance with one or more example embodiments of the present disclosure.

FIG. 9 illustrates a flow diagram of illustrative process for an illustrative enhanced wireless frame security system, in accordance with one or more example embodiments of the present disclosure.

FIG. 10 illustrates a functional diagram of an exemplary communication station that may be suitable for use as a user device, in accordance with one or more example embodiments of the present disclosure.

FIG. 11 illustrates a block diagram of an example machine upon which any of one or more techniques (e.g., methods) may be performed, in accordance with one or more example embodiments of the present disclosure.

FIG. 12 is a block diagram of a radio architecture in accordance with some examples.

FIG. 13 illustrates an example front-end module circuitry for use in the radio architecture of FIG. 12, in accordance with one or more example embodiments of the present disclosure.

FIG. 14 illustrates an example radio IC circuitry for use in the radio architecture of FIG. 12, in accordance with one or more example embodiments of the present disclosure.

FIG. 15 illustrates an example baseband processing circuitry for use in the radio architecture of FIG. 12, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wi-Fi 8 (IEEE 802.11bn or ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing new and innovative features to further advance Wi-Fi technology.

The topic of trigger frame protection has been previously explored in UHR. These discussions underscored the necessity for extending protection to other control frames, with a particular emphasis on the acknowledgment protocol. Given the ever-increasing cyber-attack threats, the need for robust protection of these control frames has become critically important.

Historically, verifying acknowledgment has presented a significant challenge due to the complexity involved in enhancing the security of control frames. Such frames include various types of Block Acknowledgments (BA), standard Acknowledgments (Ack), and different forms of Block Acknowledgment Requests (BAR). The protection of these frames has been particularly challenging to implement, due to the intricate nature of these protocols.

However, as progress has been made in the realm of trigger frame protection, new possibilities have emerged. This advancement now makes it feasible to consider the protection of acknowledgment-related frames such as BAR, BA, and Ack. The availability of effective trigger frame protection provides a stepping stone towards improved security for these essential control frames.

Existing solutions have been designed to bolster the protection of block acknowledgments for BAR and multi-User Block Acknowledgment Requests (MU-BAR). These solutions are pivotal, as they provide the first line of defense against potential cyber threats.

There have been discussions concerning Acknowledgment protection, proposing several measures to enhance frame security. These proposed enhancements include the incorporation of key Identification (ID), Message Integrity Code (MIC), Packet Number (PN), and padding in frames. These security measures are particularly relevant to frames such as multi-station (multi-STA) BA, Compressed BA, Multiple Traffic Identifier (multi-TID) BA, and multi-TID BAR.

Finally, the implementation of trigger frame protection enables the protection of MU-BAR, which can, in turn, be used to safeguard BAR for Downlink (DL). This represents a significant advancement in the realm of control frame protection, offering a new layer of security that has previously been difficult to achieve.

Protected block ack for BAR and MU-BAR essentially disables the usage of SSN in BAR and MU-BAR. Further, a separate frame is required for the exchange.

Trigger frame protection does not enable protection for any variants of BAR for UL because AP does not support reception of Trigger frame.

Padding has been suggested for the processing of MIC due to the late indication of Key ID. Further, this disclosure does not consider the exact truncation discussion for MIC and does not consider the option to protect compressed BAR.

Example embodiments of the present disclosure relate to systems, methods, and devices for acknowledgment protocol protection.

Various BAR variants are employed to optimize data transmission between APs and STAs. For example, BAR is a control frame sent by a device to request acknowledgment for a series of frames sent. The BAR variants include Basic BAR, Immediate BAR, Delayed BAR, Multi-TID BAR, Compressed BAR, and Two-ACK BAR. Each variant serves a specific purpose, ranging from immediate acknowledgment requirements in time-sensitive scenarios to efficient management of multiple data streams with Multi-TID BAR. This diverse suite of BAR variants ensures robust and efficient data communication, catering to different network conditions and traffic patterns. This facilitates the dynamic use of BARs, with both APs and STAs capable of sending these requests. This bidirectional functionality allows for flexible management of uplink and downlink transmissions. In scenarios where APs do not support advanced features like reception of Trigger frames, these BAR variants play a crucial role in maintaining efficient communication.

In one or more embodiments, an enhanced wireless frame security system may propose an integrity design utilizing Key ID, PN, and MIC. This proposed design aims to streamline the operation of MIC calculation by obviating the need for additional padding. The integration of these elements into the system's design promotes a more efficient and secure approach to data integrity, contributing to a more robust system overall.

In another embodiment, an enhanced wireless frame security system may propose a design that provides protection for different variants of BAR and BA. This includes extending protection to acknowledgments, even in the absence of BA negotiation. By offering protection across a wide range of BAR and BA types, the system ensures a comprehensive safeguarding approach, providing a more secure environment for data transmission and reception.

Finally, in yet another embodiment, an enhanced wireless frame security system may discuss the concept of the right truncation of MIC for the integrity design. This innovative approach aims to reduce overhead and balance system resources effectively. The potential reduction in overhead leads to optimized resource usage, contributing to the overall efficiency and performance of the system.

In one or more embodiments, an enhanced wireless frame security system may support all BAR usages, including Single-User (SU), multi-user (MU), compressed, and Multiple Traffic Identifier (multi-TID) types, with protection. This comprehensive protection across all BAR usages enhances the reliability and security of the system, contributing to a seamless user experience.

Additionally, in another embodiment, an enhanced wireless frame security system may extend support for all acknowledgment usages with protection. This includes SU, MU, compressed, multi-TID, with or without a BA agreement. By ensuring protection for all acknowledgment usages, regardless of BA agreement, the system offers a robust safeguard against potential threats, thereby enhancing the overall data security and system reliability.

The above descriptions are for the purpose of illustration and are not meant to be limiting. Numerous other examples, configurations, processes, algorithms, etc., may exist, some of which are described in greater detail below. Example embodiments will now be described with reference to the accompanying figures.

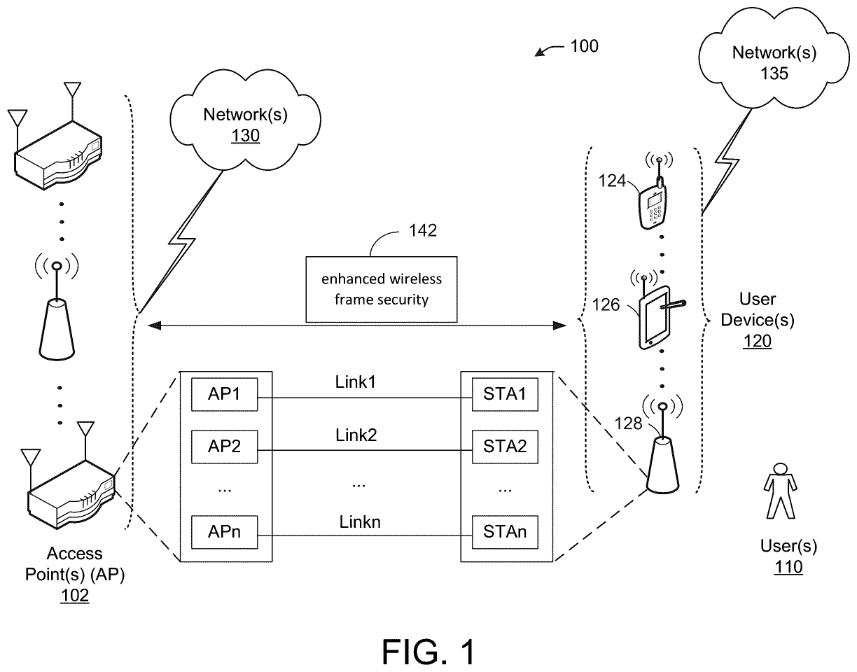

FIG. 1 is a network diagram illustrating an example network environment of enhanced wireless frame security, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

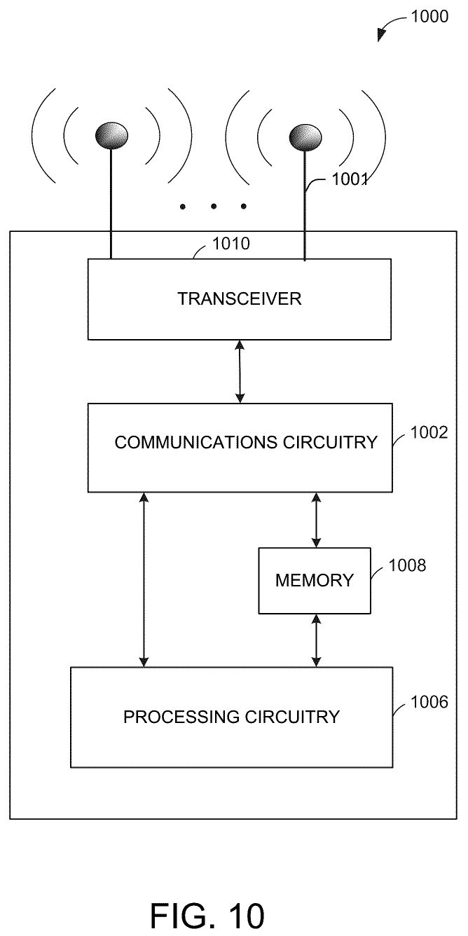

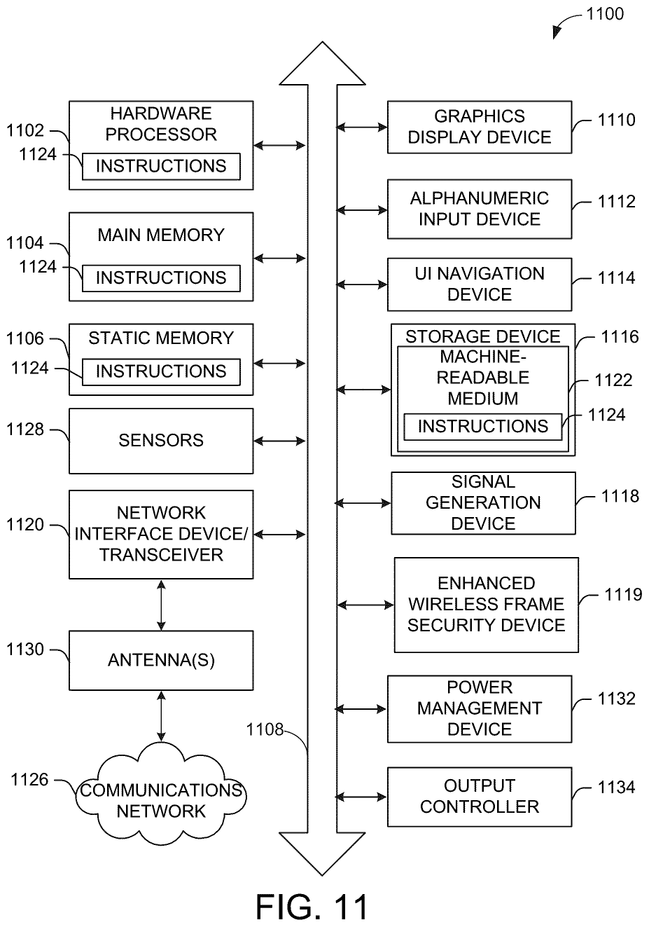

In some embodiments, the user devices 120 and the AP 102 may include one or more computer systems similar to that of the functional diagram of FIG. 10 and/or the example machine/system of FIG. 11.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QOS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, etc.), 6 GHz channels (e.g., 802.11ax, 802.11be, etc.), or 60 GHZ channels (e.g. 802.11ad, 802.11ay). 800 MHZ channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement an enhanced wireless frame security 142 with one or more user devices 120. The one or more APs 102 may be multi-link devices (MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

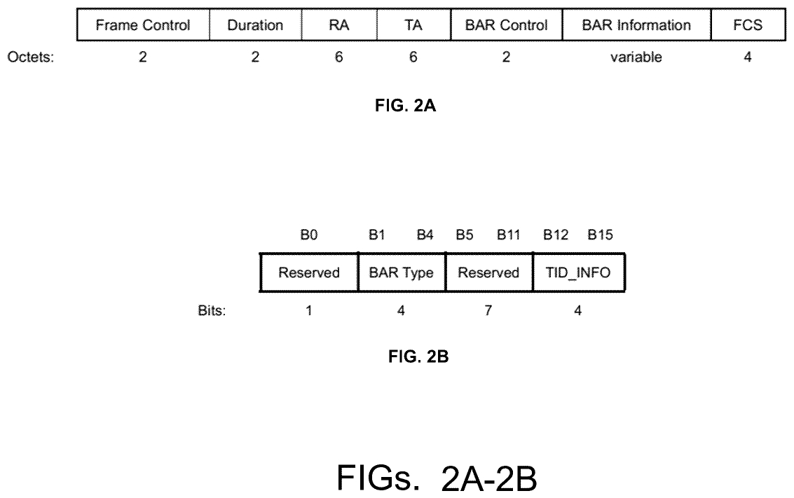

FIGS. 2A-2B depict illustrative schematic diagrams for enhanced wireless frame security, in accordance with one or more example embodiments of the present disclosure.

BAR format is shown in FIG. 2A.

The BAR control format is shown in FIG. 2B:

And the BAR Type will indicate different variants of BAR as shown in Table 1.

TABLE 1
BlockAckReq frame variant encoding:

| BAR Type | BlockAckReq frame variant |
|---|---|
| 0 | Reserved |
| 1 | Extended Compressed |
| 2 | Compressed |
| 3 | Multi-TID |
| 4-5 | Reserved |
| 6 | GCR |
| 7-9 | Reserved |
| 10 | GLK-GCR |
| 11-15 | Reserved |

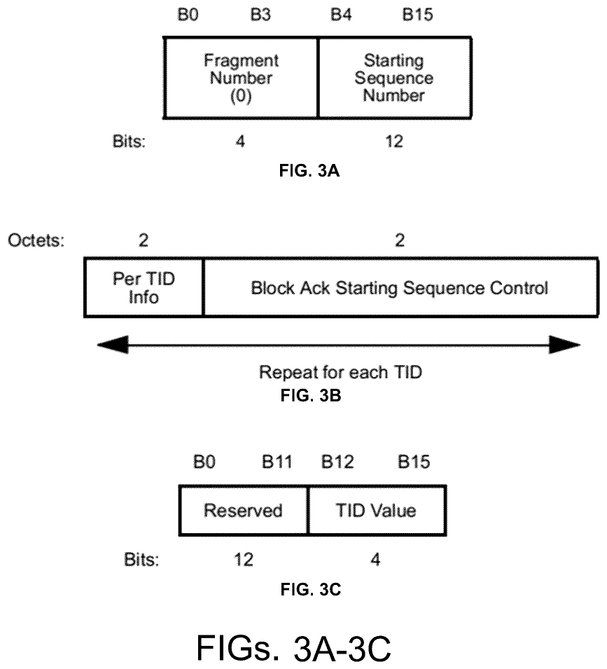

FIGS. 3A-3C depict illustrative schematic diagrams for enhanced wireless frame security, in accordance with one or more example embodiments of the present disclosure.

The ones that are relevant for UHR will be compressed and multi-TID and the formats of them for BAR Information are shown below.

BAR Information for compressed BA is shown in FIG. 3A (Block Ack Starting Sequence Control subfield format).

BAR Information for multi-TID BA is shown in FIG. 3B (BAR information field format (multi-TID BlockAckReq)) and 3C (Per TID Info subfield format).

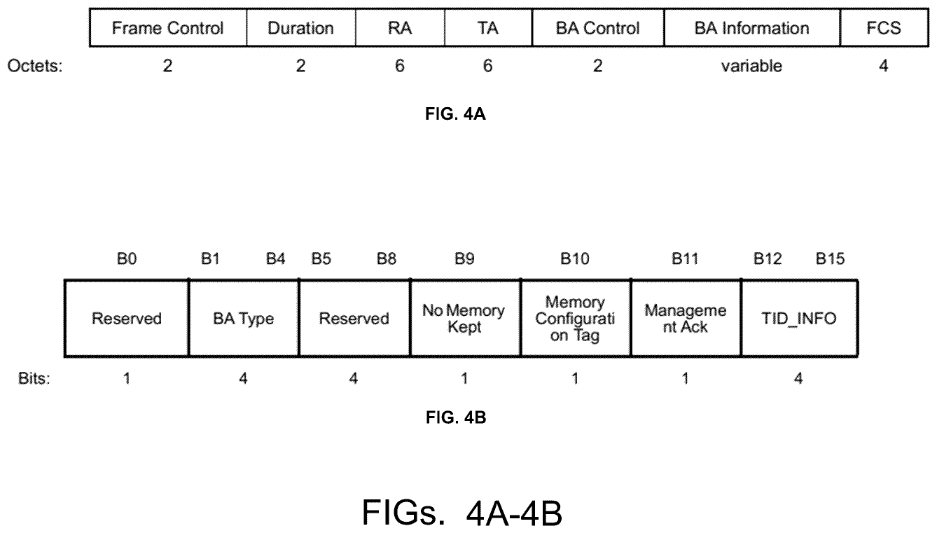

FIGS. 4A-4B depict illustrative schematic diagrams for enhanced wireless frame security, in accordance with one or more example embodiments of the present disclosure.

BA frame format is shown in FIG. 4A.

BA Control format is shown in FIG. 4B.

The BA Type will indicate different variants of BA as shown in Table 2.

TABLE 2
BlockAck Frame Variant Encoding:

| BA Type | BlockAck frame variant |
|---|---|
| 0 | Reserved |
| 1 | Extended Compressed |
| 2 | Compressed |
| 3 | Multi-TID |
| 4-5 | Reserved |
| 6 | GCR |
| 7(11ay) | EDMG Multi-TID |
| 8(11ay) | EDMG Compressed |
| 9(11ay) | Reserved |
| 10 | GLK-GCR |
| 11 | Multi-STA |
| 12-15 | Reserved |

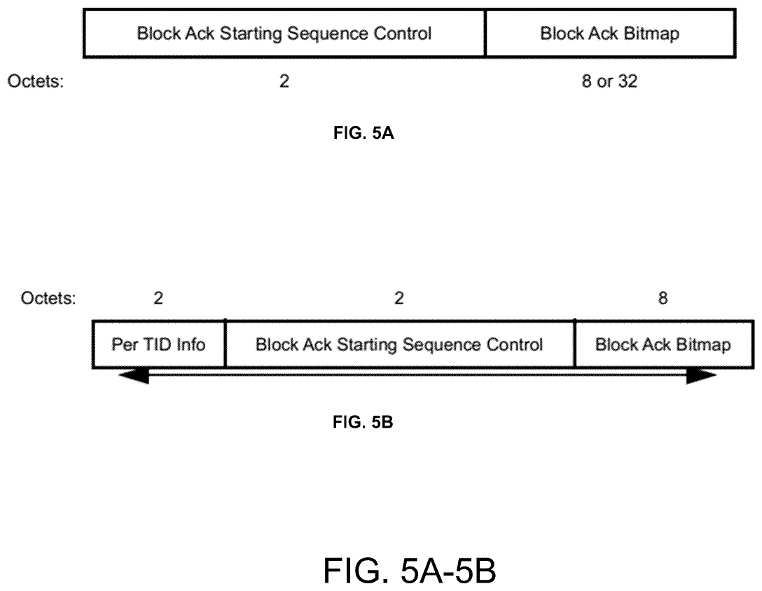

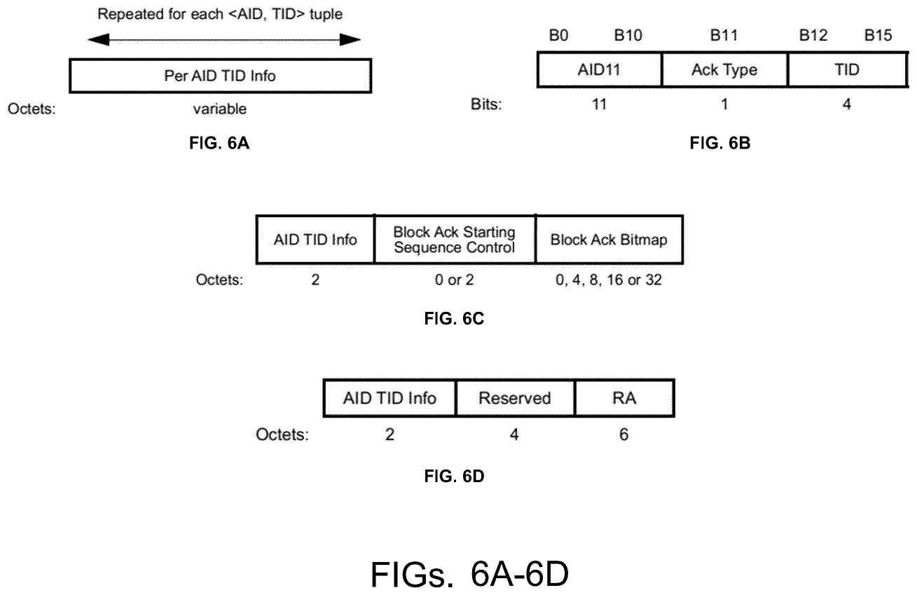

FIGS. 5A-5B and 6A-6D depict illustrative schematic diagrams for enhanced wireless frame security, in accordance with one or more example embodiments of the present disclosure.

BA Information field format of compressed BlockAck is shown in FIG. 5A.

BA Information field format of multi-TID BlockAck is shown in FIG. 5B.

BA Information field format of multi-STA BlockAck is shown in FIG. 6A.

AID TID Info subfield format is shown in FIG. 6B.

The format of Per AID TID Info is shown in FIG. 6C (Per AID TID Info Subfield Format if the AID11 subfield is not 2045) and 6D (Per AID TID Info Subfield Format if the AID11 subfield is 2045). To represent the number 2045, a minimum of 11 bits is required. This is because 2∧11 (or 2048) is the smallest power of 2 that is equal to or greater than 2045.

In the field of cryptography, the term “plaintext” refers to unencrypted information that is awaiting input into cryptographic algorithms, with a typical focus on encryption algorithms. This plaintext forms the raw data that requires security measures to ensure confidentiality, integrity, and authentication.

The term “protection” in this context can be interpreted in two distinct ways, each relating to a different aspect of cryptographic security. Firstly, an “integrity protocol” refers to a method that does not involve encrypting the plaintext itself. Instead, this protocol focuses solely on verifying the integrity of the data. This is achieved by appending a Message Integrity Code (MIC) to the plaintext. The MIC acts as a cryptographic checksum, ensuring that any alterations to the data during transit are detectable. This approach is crucial in scenarios where confidentiality of the plaintext is not a concern, but where it is vital to confirm that the data has not been tampered with.

Secondly, “authentication encryption protocol” takes a more comprehensive approach. This protocol not only encrypts the plaintext, thereby ensuring its confidentiality, but also includes a MIC for integrity verification. By combining encryption with a MIC, this protocol ensures that the data remains confidential, and that its integrity is maintained during transmission. This dual functionality is especially important in environments where both the privacy and the authenticity of the data are critical.

In summary, within a cryptographic framework, “protection” can imply either ensuring the integrity of data without encrypting it (as in an integrity protocol) or providing both encryption and integrity checks (as in an authentication encryption protocol). Both protocols serve crucial roles in maintaining the security and trustworthiness of data in digital communication systems.

For any variants of protected BA and BAR, if an integrity protocol is used, such as Cipher-based Message Authentication Code (CMAC) or Galois Message Authentication Code (GMAC), this disclosure proposes to mandate GMAC-256 (GMAC with 256-bit key) as the algorithm to produce PN and MIC for integrity design. As another alternative, the Access Point (AP) can indicate the cipher to be used, which can be CMAC-128, CMAC-256, GMAC-128, or GMAC-256. The indication can be included in the Robust Secure Network Element Extension (RSNXE), a component that enhances wireless network security by extending the capabilities of the Robust Secure Network, with improved features such as advanced encryption and authentication methods, to fortify the security framework of Wi-Fi networks.

For any variants of protected BA and BAR, if an integrity protocol is used, this disclosure proposes to have a key ID indication in the BA control or BAR control field. The same bit location is used for BA control or BAR control. Bit 0, Bit 5, Bit 6, Bit 7, or Bit 8 (i.e., B0, B5, B6, B7, or B8) in BAR control for any BAR variants or BA control for any BA variants are available. The early indication of Key ID will enable stream operation of MIC calculation while reception of the frame is ongoing. It should be understood that the Key ID is an identifier used to reference a specific cryptographic key. In the realm of data security and network communications, multiple keys might be in use for various purposes, such as encryption, authentication, or integrity verification. A Key ID allows systems to quickly identify which specific key should be used in a given context. This is important for efficiently managing and utilizing multiple keys within a network.

For any variants of protected BA and BAR, if an integrity protocol is used, as an alternative, this disclosure proposes to indicate key ID in frame control. This can be achieved by reusing the bit of To Distribution System (DS) or Frame DS, More Fragments, Retry, Protected Frame, or +High Throughput Control (+HTC), which are not currently used by the control frame. However, it should be noted that this option may not work for group addressed frames like multi-STA BA, which may be received by the legacy frame. The denomination +HTC is intended to mean that an HT control field is included.

For any variants of protected BA and BAR, if an integrity protocol is used, this disclosure proposes to have Additional Authenticated Data (AAD) construction including Frame Control, Receiver Address (RA), and Transmitter Address (TA). The mask rules follow what is defined for Broadcast Integrity Protocol (BIP) AAD construction for frame control. The BIP AAD is generated by assembling components from the Mac Protocol Data Unit (MPDU) header. This assembly process entails the following steps: Firstly, the Frame Control (FC) field of the MPDU is utilized, wherein specific subfields undergo modifications, including the masking out of the Retry subfield (bit 11), Power Management subfield (bit 12), and More Data subfield (bit 13), while leaving other subfields unaltered. Additionally, the AAD incorporates the Address 1 (A1), Address 2 (A2), and Address 3 (A3) fields of the MPDU, ensuring a comprehensive and secure data structure integral to the BIP.

For individually addressed versus group addressed protection of BA, BAR, and Ack, if an integrity protocol is used, the same key of Uplink (UL) and DL for individually addressed and group addressed protection should be used. This key is the same as the one used for Trigger frame protection for individually addressed frames. Use the same key as the Trigger frame protection for group addressed frames. The key may be announced by the AP. APs in the same multiple Basic Service Set Identifier (BSSID) set share the same key for a group addressed control frame, while APs affiliated with an AP MLD use different keys. It is possible to use the same replay counter as the Trigger frame protection reception for individually addressed frames. Also, use the same replay counter as the Trigger frame protection for group addressed frame.

For any variants of protected BA and BAR, if an integrity protocol is used, this disclosure proposes to truncate the size of MIC to 8 bytes if the size of the MIC is larger than 8 bytes. This option can be used for MIC protection of other control frames like Trigger frames. CMAC-256, GMAC-128, or GMAC-256 produce a MIC size of 16 bytes, which is larger than 8 bytes.

The requirements and guidelines for using short tags dictate that 8 bytes are the chosen length for short tags. This is due to the maximum allowable length for the MIC frame and the limited number of transmissions allowed for the frame before a rekeying process is necessary.

For 4 bytes tag, the length is either small or the number of transmission time becomes very limited. For multi-STA block, a total of 9 users per 20 MHz under 320 MHz with 128 bytes each will have a multi-STA BA with a size at least 132×9×16=19008 bytes. The 8 bytes MIC or tags is then a more suitable option for truncation.

TABLE 3
Constraints with 32-bit Tags

| Maximum Combined Length | Maximum Invocations |
|---|---|
| of the Ciphertext and AAD | of the Authenticated |
| In a Single Packet (bytes) | Decryption Function |
| 2⁵ | 2²² |
| 2⁶ | 2²⁰ |
| 2⁷ | 2¹⁸ |
| 2⁸ | 2¹⁵ |
| 2⁹ | 2¹³ |
| 2¹⁰ | 2¹¹ |

TABLE 4
Constraints with 64-bit Tags

| Maximum Combined Length | Maximum Invocations |
|---|---|
| of the Ciphertext and AAD | of the Authenticated |
| In a Single Packet (bytes) | Decryption Function |
| 2¹⁵ | 2³² |
| 2¹⁷ | 2²⁹ |
| 2¹⁹ | 2²⁶ |
| 2²¹ | 2²³ |
| 2²³ | 2²⁰ |
| 2²⁵ | 2¹⁷ |

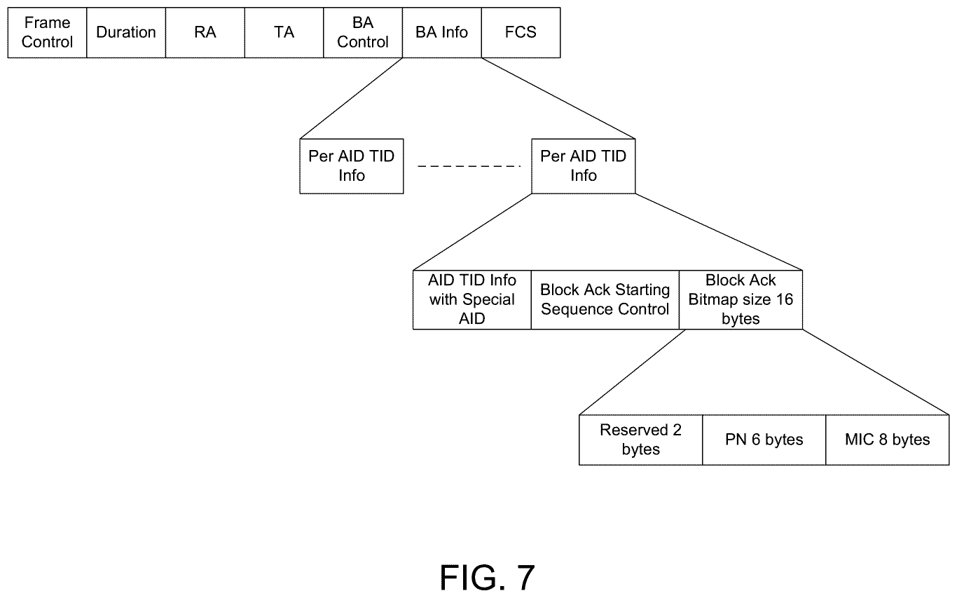

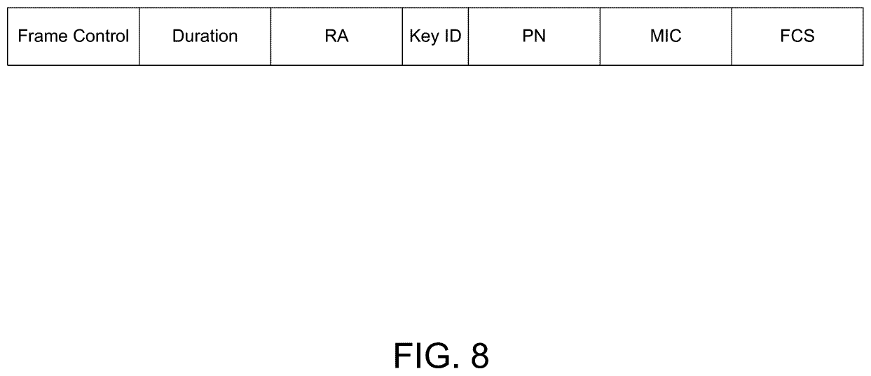

FIGS. 7 and 8 depict illustrative schematic diagrams for enhanced wireless frame security, in accordance with one or more example embodiments of the present disclosure.

In one or more embodiments, an enhanced wireless frame security system may facilitate that for protected BA and BAR, if an integrity protocol is used, not to have padding before Frame Check Sequence (FCS) for any variants. Instead, a general solution of having PN and MIC right before FCS for any variants is suggested.

In one or more embodiments, for multi-STA BA, to avoid other STAs misinterpreting the MIC and PN as another valid acknowledgment for the STA, MIC and PN will be inside a per-AID TID info subfield. A special AID that is not used by any STA will be allocated.

In one or more embodiments, the Ack Type, TID, and Block Ack Starting Sequence Control will indicate a value that leads to a Block Ack Bitmap size larger than the size of PN and MIC. A Block Ack Bitmap size of 16 bytes is possible if the size of MIC is truncated to 8 bytes. PN and MIC will use the end bits of the Block Ack Bitmap.

In one or more embodiments, the corresponding per-AID TID Info subfield will be the last per-AID TID info subfield. An example is provided in FIG. 7 for further clarification.

In one or more embodiments, for Compressed BA and multi-TID BA, this disclosure suggests several alternative options. One such option is to disallow the usage of compressed BA and multi-TID BA, and instead consistently use multi-STA BA, utilizing the design under multi-STA BA for protection.

Another alternative is to define new protected variants of compressed BA and multi-TID BA in the BA Type for the added PN and MIC. Alternatively, the existing definitions of compressed BA and multi-TID BA variants in BA Type could be reused to incorporate MIC and PN. As compressed BA and multi-TID BA are individually addressed, PN and MIC can simply be added right before the FCS if both sides agree to use the protected version of BA.

For Compressed Block Acknowledgment Requests (BAR) and multi-TID BAR, this disclosure proposes to either define new protected variants of compressed BAR and multi-TID BAR in the BAR Type for the added PN and MIC or to reuse the definitions of compressed BAR and multi-TID BAR variants in BAR Type to include additional MIC and PN. Since compressed BAR and multi-TID BAR are individually addressed, PN and MIC can be added right before FCS if both sides agree to use the protected version of BAR.

In terms of protected Ack, if an integrity protocol is used, it may be possible to disallow the usage of Ack and always use multi-STA BA instead. In this case, Ack Type 1 would be employed.

TABLE 5
context of the Per AID TID info subfield and presence
of optional subfields if AID11 subfield is not 2045.

| Ack | | Presence of Block Ack | |
|---|---|---|---|
| Type | TID | Starting Sequence Control | |
| subfield | subfield | subfield and Block Ack | Context of a Per AID TID Info subfield in a |
| values | values | Bitmap subfields | Multi-STA BlockAck frame |
| 1 | 0-7 | Not present | Acknowledgment context: |
| | | | Sent as an acknowledgment to a QoS Data or QoS Null |
| | | | frame that solicits an Ack frame response. |
| 0 or 1 | 8-13 | N/A | Reserved |
| 0 | 14 | N/A | Reserved |
| 1 | 14 | Not present | All ack context: |
| | | | Sent as an acknowledgment to an A-MPDU that contains |
| | | | an MPDU that solicits an immediate response and all |
| | | | MPDUs contained in the A-MPDU are received |
| | | | successfully. |
| 0 | 15 | N/A | Reserved |
| 1 | 15 | Not present | Management/PS-Poll frame acknowledgment context: |
| | | | Sent as an acknowledgment to a Management or PS-Poll |
| | | | frame. |

NOTE 1-
Additional rules for acknowledgment, block acknowledgment and the all ack context are defined in 26.4.2 (Acknowledgment context in a Multi-STA BlockAck frame) for a multi-TID A-MPDU.
NOTE 2-
As HE STAs do not use HCCA (see 10.23.1 (General)), TID values from 8 to 15 are not used in QoS Data frames.

In one or more embodiments, an enhanced wireless frame security system may define a new Ack format between two UHR STAs that support the protected acknowledgment as shown below. Can reuse the same type and subtype of Ack frame. Have an unused type and subtype for the new format as shown in FIG. 8.

AAD construction including Frame Control and RA. The mask rules follow what is defined for BIPAAD construction for frame control. The BIP AAD is generated by assembling components from the Mac Protocol Data Unit (MPDU) header. This assembly process entails the following steps: Firstly, the Frame Control (FC) field of the MPDU is utilized, wherein specific subfields undergo modifications, including the masking out of the Retry subfield (bit 11), Power Management subfield (bit 12), and More Data subfield (bit 13), while leaving other subfields unaltered. Additionally, the AAD incorporates the Address 1 (A1), Address 2 (A2), and Address 3 (A3) fields of the MPDU, ensuring a comprehensive and secure data structure integral to the BIP.

For protected variants of BA, BAR, and Trigger frames, this disclosure proposes several alternatives. One such alternative is to employ an integrity protocol like Cipher-based Message Authentication Code (CMAC) or Galois/Counter Mode (GMAC), or simply to encrypt the frames using authentication encryption protocol using Counter Mode Cipher Block Chaining Message Authentication Code Protocol (CCMP) or Galois/Counter Mode Protocol (GCMP). In this case, Mandate GCMP with 256 bit key. Further, the Protected Frame field in the Frame control would be set to 1.

It is mandated to use the same cipher as the individually addressed data or management frame encryption for individually addressed frames and the same cipher as group addressed data frame encryption for group addressed frames. A key different from the Temporal Key (TK) used for the encryption of individual addressed data or management frames is to be employed.

There should be a separate key for individually addressed or group addressed control frames. For multi-link operations, the used key will be different for each link. The key for group addressed control frames is announced by the Access Point (AP) in each link. The key for individually addressed frames in each link is derived from the Key Derivation Key (KDK).

The disclosure also suggests having a separate replay counter different from the replay counter for Data frames or Management frames. The fields for encryption of any variants of BA, BAR, or Trigger frames are defined as the fields after the Transmitter Address (TA) and before the FCS. The MAC header fields for CCMP or GCMP are defined as the fields before and including the TA.

AAD construction includes the Frame control, with the Power Management subfield and More Data subfield masked out, as well as TA and Receiver Address (RA). Nonce construction follows CCMP or GCMP for the MPDU. In CCMP, the priority field is set to 0.

It is understood that the above descriptions are for the purposes of illustration and are not meant to be limiting.

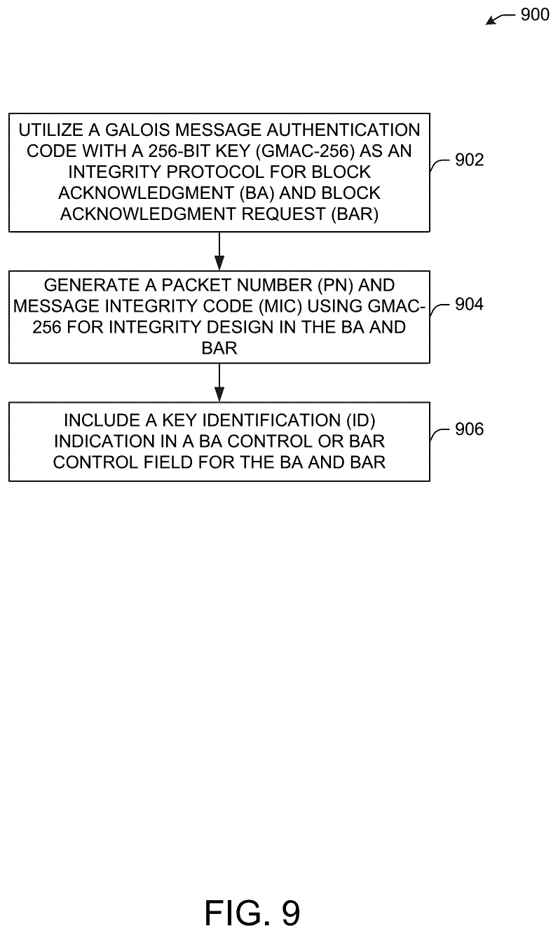

FIG. 9 illustrates a flow diagram of illustrative process 900 for an enhanced wireless frame security system, in accordance with one or more example embodiments of the present disclosure.

At block 902, a device (e.g., the user device(s) 120 and/or the AP 102 of FIG. 1 and/or the enhanced wireless frame security device 1119 of FIG. 11) may utilize a Galois Message Authentication Code with a 256-bit key (GMAC-256) as an integrity protocol for block acknowledgment (BA) and block acknowledgment request (BAR)

At block 904, the device may generate a packet number (PN) and Message Integrity Code (MIC) using GMAC-256 for integrity design in the BA and BAR

At block 906, the device may include a key identification (ID) indication in a BA control or BAR control field for the BA and BAR.

In one or more embodiments, The device may be configured to construct Additional Authenticated Data (AAD) for the BA and BAR, including incorporating a Frame Control (FC) field of the BA and BAR with specific subfields modifications, and may include a receiving station address (RA), and a transmitting station address (TA). The device may modify specific subfields in the FC field to mask out the Retry, Power Management, and More Data subfields. It may also be configured to truncate the size of the MIC to 8 bytes if the original size of the MIC is larger than 8 bytes. Additionally, the device may use the same key for individually addressed and group addressed frame protection as used for Trigger frame protection. It may utilize the same replay counter as used for Trigger frame protection for both individually addressed and group addressed frames. The GMAC-256 may be mandated for use in all variants of the BA and BAR where an integrity protocol is applied. The device may include the PN and MIC for both protected BA and BAR right before the FCS is checked by a receiver. For Multi-STA BA, a per AID-TID info subfield with special AID may be used to include the PN and MIC. Furthermore, the device may encrypt one or more control frames using authentication encryption protocols including Galois/counter mode protocol (GCMP) with a 256-bit key; and may set a protected frame subfield field in a frame control field to be equal to “1.”

It is understood that the above descriptions are for the purposes of illustration and are not meant to be limiting.

FIG. 10 shows a functional diagram of an exemplary communication station 1000, in accordance with one or more example embodiments of the present disclosure. In one embodiment, FIG. 10 illustrates a functional block diagram of a communication station that may be suitable for use as an AP 102 (FIG. 1) or a user device 120 (FIG. 1) in accordance with some embodiments. The communication station 1000 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1000 may include communications circuitry 1002 and a transceiver 1010 for transmitting and receiving signals to and from other communication stations using one or more antennas 1001. The communications circuitry 1002 may include circuitry that can operate the physical layer (PHY) communications and/or medium access control (MAC) communications for controlling access to the wireless medium, and/or any other communications layers for transmitting and receiving signals. The communication station 1000 may also include processing circuitry 1006 and memory 1008 arranged to perform the operations described herein. In some embodiments, the communications circuitry 1002 and the processing circuitry 1006 may be configured to perform operations detailed in the above figures, diagrams, and flows.

In accordance with some embodiments, the communications circuitry 1002 may be arranged to contend for a wireless medium and configure frames or packets for communicating over the wireless medium. The communications circuitry 1002 may be arranged to transmit and receive signals. The communications circuitry 1002 may also include circuitry for modulation/demodulation, upconversion/downconversion, filtering, amplification, etc. In some embodiments, the processing circuitry 1006 of the communication station 1000 may include one or more processors. In other embodiments, two or more antennas 1001 may be coupled to the communications circuitry 1002 arranged for sending and receiving signals. The memory 1008 may store information for configuring the processing circuitry 1006 to perform operations for configuring and transmitting message frames and performing the various operations described herein. The memory 1008 may include any type of memory, including non-transitory memory, for storing information in a form readable by a machine (e.g., a computer). For example, the memory 1008 may include a computer-readable storage device, read-only memory (ROM), random-access memory (RAM), magnetic disk storage media, optical storage media, flash-memory devices and other storage devices and media.

In some embodiments, the communication station 1000 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1000 may include one or more antennas 1001. The antennas 1001 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1000 may include one or more of a keyboard, a display, a non-volatile memory port, multiple antennas, a graphics processor, an application processor, speakers, and other mobile device elements. The display may be an LCD screen including a touch screen.

Although the communication station 1000 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1000 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1000 may include one or more processors and may be configured with instructions stored on a computer-readable storage device.

FIG. 11 illustrates a block diagram of an example of a machine 1100 or system upon which any one or more of the techniques (e.g., methodologies) discussed herein may be performed. In other embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environments. The machine 1100 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108. The machine 1100 may further include a power management device 1132, a graphics display device 1110, an alphanumeric input device 1112 (e.g., a keyboard), and a user interface (UI) navigation device 1114 (e.g., a mouse). In an example, the graphics display device 1110, alphanumeric input device 1112, and UI navigation device 1114 may be a touch screen display. The machine 1100 may additionally include a storage device (i.e., drive unit) 1116, a signal generation device 1118 (e.g., a speaker), an enhanced wireless frame security device 1119, a network interface device/transceiver 1120 coupled to antenna(s) 1130, and one or more sensors 1128, such as a global positioning system (GPS) sensor, a compass, an accelerometer, or other sensor. The machine 1100 may include an output controller 1134, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1102 for generation and processing of the baseband signals and for controlling operations of the main memory 1104, the storage device 1116, and/or the enhanced wireless frame security device 1119. The baseband processor may be provided on a single radio card, a single chip, or an integrated circuit (IC).

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within the static memory 1106, or within the hardware processor 1102 during execution thereof by the machine 1100. In an example, one or any combination of the hardware processor 1102, the main memory 1104, the static memory 1106, or the storage device 1116 may constitute machine-readable media.

The enhanced wireless frame security device 1119 may carry out or perform any of the operations and processes (e.g., process 900) described and shown above.

It is understood that the above are only a subset of what the enhanced wireless frame security device 1119 may be configured to perform and that other functions included throughout this disclosure may also be performed by the enhanced wireless frame security device 1119.

While the machine-readable medium 1122 is illustrated as a single medium, the term “machine-readable medium” may include a single medium or multiple media (e.g., a centralized or distributed database, and/or associated caches and servers) configured to store the one or more instructions 1124.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1100 and that cause the machine 1100 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1124 may further be transmitted or received over a communications network 1126 using a transmission medium via the network interface device/transceiver 1120 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1120 may include one or more physical jacks (e.g., Ethernet, coaxial, or phone jacks) or one or more antennas to connect to the communications network 1126. In an example, the network interface device/transceiver 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1100 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

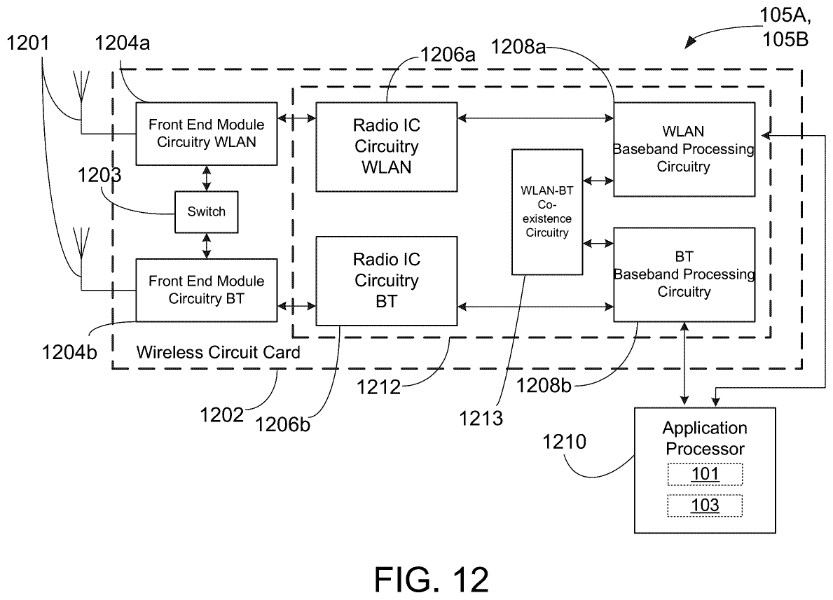

FIG. 12 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 1204a-b, radio IC circuitry 1206a-b and baseband processing circuitry 1208a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1204a-b may include a WLAN or Wi-Fi FEM circuitry 1204a and a Bluetooth (BT) FEM circuitry 1204b. The WLAN FEM circuitry 1204a may include a receive signal path comprising circuitry configured to operate on WLAN RF signals received from one or more antennas 1201, to amplify the received signals and to provide the amplified versions of the received signals to the WLAN radio IC circuitry 1206a for further processing. The BT FEM circuitry 1204b may include a receive signal path which may include circuitry configured to operate on BT RF signals received from one or more antennas 1201, to amplify the received signals and to provide the amplified versions of the received signals to the BT radio IC circuitry 1206b for further processing. FEM circuitry 1204a may also include a transmit signal path which may include circuitry configured to amplify WLAN signals provided by the radio IC circuitry 1206a for wireless transmission by one or more of the antennas 1201. In addition, FEM circuitry 1204b may also include a transmit signal path which may include circuitry configured to amplify BT signals provided by the radio IC circuitry 1206b for wireless transmission by the one or more antennas. In the embodiment of FIG. 12, although FEM 1204a and FEM 1204b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1206a-b as shown may include WLAN radio IC circuitry 1206a and BT radio IC circuitry 1206b. The WLAN radio IC circuitry 1206a may include a receive signal path which may include circuitry to down-convert WLAN RF signals received from the FEM circuitry 1204a and provide baseband signals to WLAN baseband processing circuitry 1208a. BT radio IC circuitry 1206b may in turn include a receive signal path which may include circuitry to down-convert BT RF signals received from the FEM circuitry 1204b and provide baseband signals to BT baseband processing circuitry 1208b. WLAN radio IC circuitry 1206a may also include a transmit signal path which may include circuitry to up-convert WLAN baseband signals provided by the WLAN baseband processing circuitry 1208a and provide WLAN RF output signals to the FEM circuitry 1204a for subsequent wireless transmission by the one or more antennas 1201. BT radio IC circuitry 1206b may also include a transmit signal path which may include circuitry to up-convert BT baseband signals provided by the BT baseband processing circuitry 1208b and provide BT RF output signals to the FEM circuitry 1204b for subsequent wireless transmission by the one or more antennas 1201. In the embodiment of FIG. 12, although radio IC circuitries 1206a and 1206b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1208a-b may include a WLAN baseband processing circuitry 1208a and a BT baseband processing circuitry 1208b. The WLAN baseband processing circuitry 1208a may include a memory, such as, for example, a set of RAM arrays in a Fast Fourier Transform or Inverse Fast Fourier Transform block (not shown) of the WLAN baseband processing circuitry 1208a. Each of the WLAN baseband circuitry 1208a and the BT baseband circuitry 1208b may further include one or more processors and control logic to process the signals received from the corresponding WLAN or BT receive signal path of the radio IC circuitry 1206a-b, and to also generate corresponding WLAN or BT baseband signals for the transmit signal path of the radio IC circuitry 1206a-b. Each of the baseband processing circuitries 1208a and 1208b may further include physical layer (PHY) and medium access control layer (MAC) circuitry, and may further interface with a device for generation and processing of the baseband signals and for controlling operations of the radio IC circuitry 1206a-b.

Referring still to FIG. 12, according to the shown embodiment, WLAN-BT coexistence circuitry 1213 may include logic providing an interface between the WLAN baseband circuitry 1208a and the BT baseband circuitry 1208b to enable use cases requiring WLAN and BT coexistence. In addition, a switch 1203 may be provided between the WLAN FEM circuitry 1204a and the BT FEM circuitry 1204b to allow switching between the WLAN and BT radios according to application needs. In addition, although the antennas 1201 are depicted as being respectively connected to the WLAN FEM circuitry 1204a and the BT FEM circuitry 1204b, embodiments include within their scope the sharing of one or more antennas as between the WLAN and BT FEMs, or the provision of more than one antenna connected to each of FEM 1204a or 1204b.

In some embodiments, the front-end module circuitry 1204a-b, the radio IC circuitry 1206a-b, and baseband processing circuitry 1208a-b may be provided on a single radio card, such as wireless radio card 1202. In some other embodiments, the one or more antennas 1201, the FEM circuitry 1204a-b and the radio IC circuitry 1206a-b may be provided on a single radio card. In some other embodiments, the radio IC circuitry 1206a-b and the baseband processing circuitry 1208a-b may be provided on a single chip or integrated circuit (IC), such as IC 1212.

In some embodiments, the wireless radio card 1202 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 1208b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHZ, 2.4 GHZ, 5 GHZ, and bandwidths of about 2 MHz, 4 MHZ, 5 MHz, 5.5 MHz, 6 MHZ, 8 MHz, 10 MHZ, 20 MHz, 40 MHz, 80 MHZ (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies, however.

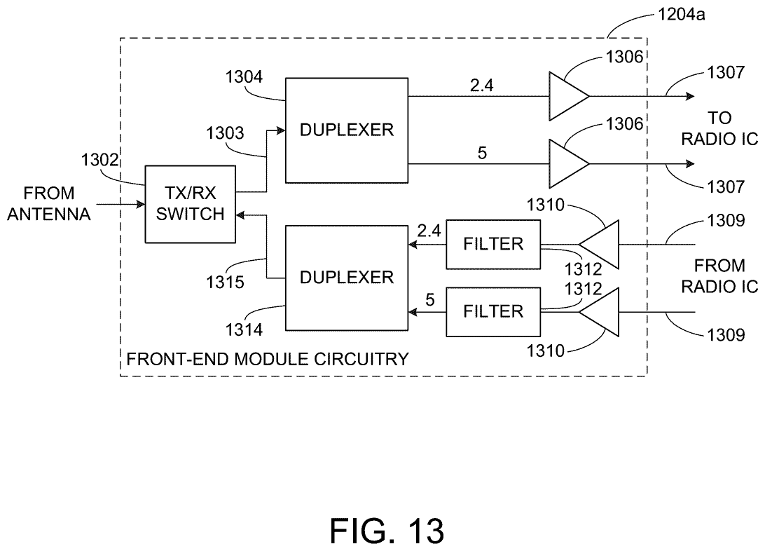

FIG. 13 illustrates WLAN FEM circuitry 1204a in accordance with some embodiments. Although the example of FIG. 13 is described in conjunction with the WLAN FEM circuitry 1204a, the example of FIG. 13 may be described in conjunction with the example BT FEM circuitry 1204b (FIG. 12), although other circuitry configurations may also be suitable.

In some embodiments, the FEM circuitry 1204a may include a TX/RX switch 1302 to switch between transmit mode and receive mode operation. The FEM circuitry 1204a may include a receive signal path and a transmit signal path. The receive signal path of the FEM circuitry 1204a may include a low-noise amplifier (LNA) 1306 to amplify received RF signals 1303 and provide the amplified received RF signals 1307 as an output (e.g., to the radio IC circuitry 1206a-b (FIG. 12)). The transmit signal path of the circuitry 1204a may include a power amplifier (PA) to amplify input RF signals 1309 (e.g., provided by the radio IC circuitry 1206a-b), and one or more filters 1312, such as band-pass filters (BPFs), low-pass filters (LPFs) or other types of filters, to generate RF signals 1315 for subsequent transmission (e.g., by one or more of the antennas 1201 (FIG. 12)) via an example duplexer 1314.

In some dual-mode embodiments for Wi-Fi communication, the FEM circuitry 1204a may be configured to operate in either the 2.4 GHz frequency spectrum or the 5 GHz frequency spectrum. In these embodiments, the receive signal path of the FEM circuitry 1204a may include a receive signal path duplexer 1304 to separate the signals from each spectrum as well as provide a separate LNA 1306 for each spectrum as shown. In these embodiments, the transmit signal path of the FEM circuitry 1204a may also include a power amplifier 1310 and a filter 1312, such as a BPF, an LPF or another type of filter for each frequency spectrum and a transmit signal path duplexer 1304 to provide the signals of one of the different spectrums onto a single transmit path for subsequent transmission by the one or more of the antennas 1201 (FIG. 12). In some embodiments, BT communications may utilize the 2.4 GHz signal paths and may utilize the same FEM circuitry 1204a as the one used for WLAN communications.

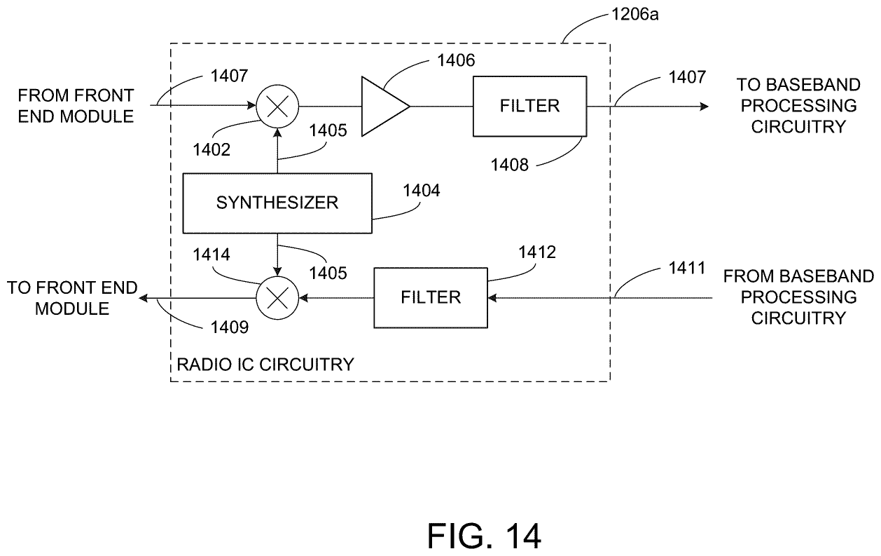

FIG. 14 illustrates radio IC circuitry 1206a in accordance with some embodiments. The radio IC circuitry 1206a is one example of circuitry that may be suitable for use as the WLAN or BT radio IC circuitry 1206a/1206b (FIG. 12), although other circuitry configurations may also be suitable. Alternatively, the example of FIG. 14 may be described in conjunction with the example BT radio IC circuitry 1206b.

In some embodiments, the radio IC circuitry 1206a may include a receive signal path and a transmit signal path. The receive signal path of the radio IC circuitry 1206a may include at least mixer circuitry 1402, such as, for example, down-conversion mixer circuitry, amplifier circuitry 1406 and filter circuitry 1408. The transmit signal path of the radio IC circuitry 1206a may include at least filter circuitry 1412 and mixer circuitry 1414, such as, for example, upconversion mixer circuitry. Radio IC circuitry 1206a may also include synthesizer circuitry 1404 for synthesizing a frequency 1405 for use by the mixer circuitry 1402 and the mixer circuitry 1414. The mixer circuitry 1402 and/or 1414 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 14 illustrates only a simplified version of a radio IC circuitry, and may include, although not shown, embodiments where each of the depicted circuitries may include more than one component. For instance, mixer circuitry 1414 may each include one or more mixers, and filter circuitries 1408 and/or 1412 may each include one or more filters, such as one or more BPFs and/or LPFs according to application needs. For example, when mixer circuitries are of the direct-conversion type, they may each include two or more mixers.

In some embodiments, mixer circuitry 1402 may be configured to down-convert RF signals 1307 received from the FEM circuitry 1204a-b (FIG. 12) based on the synthesized frequency 1405 provided by synthesizer circuitry 1404. The amplifier circuitry 1406 may be configured to amplify the down-converted signals and the filter circuitry 1408 may include an LPF configured to remove unwanted signals from the down-converted signals to generate output baseband signals 1407. Output baseband signals 1407 may be provided to the baseband processing circuitry 1208a-b (FIG. 12) for further processing. In some embodiments, the output baseband signals 1407 may be zero-frequency baseband signals, although this is not a requirement. In some embodiments, mixer circuitry 1402 may comprise passive mixers, although the scope of the embodiments is not limited in this respect.

In some embodiments, the mixer circuitry 1414 may be configured to up-convert input baseband signals 1411 based on the synthesized frequency 1405 provided by the synthesizer circuitry 1404 to generate RF output signals 1309 for the FEM circuitry 1204a-b. The baseband signals 1411 may be provided by the baseband processing circuitry 1208a-b and may be filtered by filter circuitry 1412. The filter circuitry 1412 may include an LPF or a BPF, although the scope of the embodiments is not limited in this respect.

In some embodiments, the mixer circuitry 1402 and the mixer circuitry 1414 may each include two or more mixers and may be arranged for quadrature down-conversion and/or upconversion respectively with the help of synthesizer 1404. In some embodiments, the mixer circuitry 1402 and the mixer circuitry 1414 may each include two or more mixers each configured for image rejection (e.g., Hartley image rejection). In some embodiments, the mixer circuitry 1402 and the mixer circuitry 1414 may be arranged for direct down-conversion and/or direct upconversion, respectively. In some embodiments, the mixer circuitry 1402 and the mixer circuitry 1414 may be configured for super-heterodyne operation, although this is not a requirement.

Mixer circuitry 1402 may comprise, according to one embodiment: quadrature passive mixers (e.g., for the in-phase (I) and quadrature phase (Q) paths). In such an embodiment, RF input signal 1307 from FIG. 14 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1405 of synthesizer 1404 (FIG. 14). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1307 (FIG. 13) may comprise a balanced signal, although the scope of the embodiments is not limited in this respect. The I and Q baseband output signals may be provided to low-noise amplifier, such as amplifier circuitry 1406 (FIG. 14) or to filter circuitry 1408 (FIG. 14).

In some embodiments, the output baseband signals 1407 and the input baseband signals 1411 may be analog baseband signals, although the scope of the embodiments is not limited in this respect. In some alternate embodiments, the output baseband signals 1407 and the input baseband signals 1411 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1404 may be a fractional-N synthesizer or a fractional N/N+1 synthesizer, although the scope of the embodiments is not limited in this respect as other types of frequency synthesizers may be suitable. For example, synthesizer circuitry 1404 may be a delta-sigma synthesizer, a frequency multiplier, or a synthesizer comprising a phase-locked loop with a frequency divider. According to some embodiments, the synthesizer circuitry 1404 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1404 may be provided by a voltage controlled oscillator (VCO), although that is not a requirement. A divider control input may further be provided by either the baseband processing circuitry 1208a-b (FIG. 12) depending on the desired output frequency 1405. In some embodiments, a divider control input (e.g., N) may be determined from a look-up table (e.g., within a Wi-Fi card) based on a channel number and a channel center frequency as determined or indicated by the example application processor 1210. The application processor 1210 may include, or otherwise be connected to, one of the example secure signal converter 101 or the example received signal converter 103 (e.g., depending on which device the example radio architecture is implemented in).

In some embodiments, synthesizer circuitry 1404 may be configured to generate a carrier frequency as the output frequency 1405, while in other embodiments, the output frequency 1405 may be a fraction of the carrier frequency (e.g., one-half the carrier frequency, one-third the carrier frequency). In some embodiments, the output frequency 1405 may be a LO frequency (fLO).

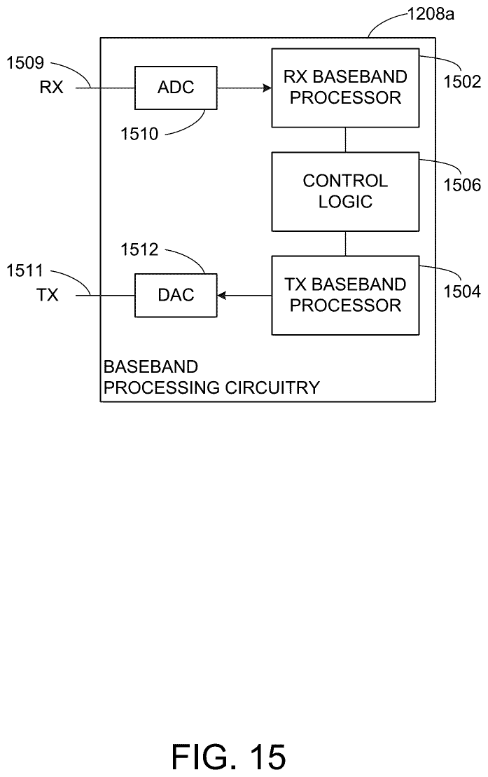

FIG. 15 illustrates a functional block diagram of baseband processing circuitry 1208a in accordance with some embodiments. The baseband processing circuitry 1208a is one example of circuitry that may be suitable for use as the baseband processing circuitry 1208a (FIG. 12), although other circuitry configurations may also be suitable. Alternatively, the example of FIG. 14 may be used to implement the example BT baseband processing circuitry 1208b of FIG. 12.

The baseband processing circuitry 1208a may include a receive baseband processor (RX BBP) 1502 for processing receive baseband signals 1409 provided by the radio IC circuitry 1206a-b (FIG. 12) and a transmit baseband processor (TX BBP) 1504 for generating transmit baseband signals 1411 for the radio IC circuitry 1206a-b. The baseband processing circuitry 1208a may also include control logic 1506 for coordinating the operations of the baseband processing circuitry 1208a.

In some embodiments (e.g., when analog baseband signals are exchanged between the baseband processing circuitry 1208a-b and the radio IC circuitry 1206a-b), the baseband processing circuitry 1208a may include ADC 1510 to convert analog baseband signals 1509 received from the radio IC circuitry 1206a-b to digital baseband signals for processing by the RX BBP 1502. In these embodiments, the baseband processing circuitry 1208a may also include DAC 1512 to convert digital baseband signals from the TX BBP 1504 to analog baseband signals 1511.

In some embodiments that communicate OFDM signals or OFDMA signals, such as through baseband processor 1208a, the transmit baseband processor 1504 may be configured to generate OFDM or OFDMA signals as appropriate for transmission by performing an inverse fast Fourier transform (IFFT). The receive baseband processor 1502 may be configured to process received OFDM signals or OFDMA signals by performing an FFT. In some embodiments, the receive baseband processor 1502 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 12, in some embodiments, the antennas 1201 (FIG. 12) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1201 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.
Example 1 may include a device comprising processing circuitry coupled to storage, the processing circuitry configured to: utilize a Galois Message Authentication Code with a 256-bit key (GMAC-256) as an integrity protocol for block acknowledgment (BA) and block acknowledgment request (BAR); generate a packet number (PN) and Message Integrity Code (MIC) using GMAC-256 for integrity design in the BA and BAR; and include a key identification (ID) indication in a BA control or BAR control field for the BA and BAR.
Example 2 may include the device of example 1 and/or some other example herein, wherein the processing circuitry may be further configured to construct Additional Authenticated Data (AAD) for the BA and BAR, including incorporating a Frame Control (FC) field of the BA and BAR with specific subfields modifications, and including a receiving station address (RA), and a transmitting station address (TA).
Example 3 may include the device of example 2 and/or some other example herein, wherein the specific subfields modifications in the FC field include masking out the Retry, Power Management, and More Data subfields.
Example 4 may include the device of example 1 and/or some other example herein, wherein the processing circuitry may be further configured to truncate the size of the MIC to 8 bytes if the original size of the MIC may be larger than 8 bytes.
Example 5 may include the device of example 1 and/or some other example herein, wherein the processing circuitry may be further configured to use the same key for individually addressed and group addressed frame protection as used for Trigger frame protection.
Example 6 may include the device of example 1 and/or some other example herein, wherein the processing circuitry may be further configured to utilize the same replay counter as used for Trigger frame protection for both individually addressed and group addressed frames.
Example 7 may include the device of example 1 and/or some other example herein, wherein the GMAC-256 may be mandated for use in all variants of the BA and BAR where an integrity protocol may be applied.
Example 8 may include the device of example 1 and/or some other example herein, wherein the PN and MIC are included for both protected BA and BAR right before the FCS is checked by a receiver.
Example 9 may include the device of example 1 and/or some other example herein, wherein for Multi-STA BA, a per AID-TID info subfield with special AID may be used to include the PN and MIC.
Example 10 may include the device of example 1 and/or some other example herein, wherein the processing circuitry may be further configured to: encrypt one or more control frames using authentication encryption protocols including Galois/counter mode protocol (GCMP) with 256-bit key; and set a protected frame subfield field in a frame control field to be equal to “1.”
Example 11 may include a non-transitory computer-readable medium storing computer-executable instructions which when executed by one or more processors result in performing operations comprising: utilizing a Galois Message Authentication Code with a 256-bit key (GMAC-256) as an integrity protocol for block acknowledgment (BA) and block acknowledgment request (BAR); generating a packet number (PN) and Message Integrity Code (MIC) using GMAC-256 for integrity design in the BA and BAR; and including a key identification (ID) indication in a BA control or BAR control field for the BA and BAR.
Example 12 may include the non-transitory computer-readable medium of example 11 and/or some other example herein, wherein the operations further comprise constructing Additional Authenticated Data (AAD) for the BA and BAR, including incorporating a Frame Control (FC) field of the BA and BAR with specific subfields modifications, and including a receiving station address (RA), and a transmitting station address (TA).
Example 13 may include the non-transitory computer-readable medium of example 12 and/or some other example herein, wherein the specific subfields modifications in the FC field include masking out the Retry, Power Management, and More Data subfields.
Example 14 may include the non-transitory computer-readable medium of example 11 and/or some other example herein, wherein the operations further comprise truncating the size of the MIC to 8 bytes if the original size of the MIC may be larger than 8 bytes.
Example 15 may include the non-transitory computer-readable medium of example 11 and/or some other example herein, wherein the operations further comprise using the same key for individually addressed and group addressed frame protection as used for Trigger frame protection.
Example 16 may include the non-transitory computer-readable medium of example 11 and/or some other example herein, wherein the operations further comprise utilizing the same replay counter as used for Trigger frame protection for both individually addressed and group addressed frames.
Example 17 may include the non-transitory computer-readable medium of example 11 and/or some other example herein, wherein the GMAC-256 may be mandated for use in all variants of the BA and BAR where an integrity protocol may be applied.
Example 18 may include the non-transitory computer-readable medium of example 11 and/or some other example herein, wherein the PN and MIC are included for both protected BA and BAR right before the FCS is checked by a receiver.
Example 19 may include the non-transitory computer-readable medium of example 11 and/or some other example herein, wherein for Multi-STA BA, a per AID-TID info subfield with special AID may be used to include the PN and MIC.
Example 20 may include the non-transitory computer-readable medium of example 11 and/or some other example herein, wherein the operations further comprise: encrypt one or more control frames using authentication encryption protocols including Galois/counter mode protocol (GCMP) with 256-bit key; and setting a protected frame subfield field in a frame control field to be equal to “1.”
Example 21 may include a method comprising: utilizing a Galois Message Authentication Code with a 256-bit key (GMAC-256) as an integrity protocol for block acknowledgment (BA) and block acknowledgment request (BAR); generating a packet number (PN) and Message Integrity Code (MIC) using GMAC-256 for integrity design in the BA and BAR; and including a key identification (ID) indication in a BA control or BAR control field for the BA and BAR.
Example 22 may include the method of example 21 and/or some other example herein, further comprising constructing Additional Authenticated Data (AAD) for the BA and BAR, including incorporating a Frame Control (FC) field of the BA and BAR with specific subfields modifications, and including a receiving station address (RA), and a transmitting station address (TA).
Example 23 may include the method of example 22 and/or some other example herein, wherein the specific subfields modifications in the FC field include masking out the Retry, Power Management, and More Data subfields.
Example 24 may include the method of example 21 and/or some other example herein, further comprising truncating the size of the MIC to 8 bytes if the original size of the MIC may be larger than 8 bytes.
Example 25 may include the method of example 21 and/or some other example herein, further comprising using the same key for individually addressed and group addressed frame protection as used for Trigger frame protection.
Example 26 may include the method of example 21 and/or some other example herein, further comprising utilizing the same replay counter as used for Trigger frame protection for both individually addressed and group addressed frames.
Example 27 may include the method of example 21 and/or some other example herein, wherein the GMAC-256 may be mandated for use in all variants of the BA and BAR where an integrity protocol may be applied.
Example 28 may include the method of example 21 and/or some other example herein, wherein the PN and MIC are included for both protected BA and BAR right before the FCS is checked by a receiver.
Example 29 may include the method of example 21 and/or some other example herein, wherein for Multi-STA BA, a per AID-TID info subfield with special AID may be used to include the PN and MIC.
Example 30 may include the method of example 21 and/or some other example herein, further comprising: encrypt one or more control frames using authentication encryption protocols including Galois/counter mode protocol (GCMP) with 256-bit key; and setting a protected frame subfield field in a frame control field to be equal to “1.”
Example 31 may include an apparatus comprising means for: utilizing a Galois Message Authentication Code with a 256-bit key (GMAC-256) as an integrity protocol for block acknowledgment (BA) and block acknowledgment request (BAR); generating a packet number (PN) and Message Integrity Code (MIC) using GMAC-256 for integrity design in the BA and BAR; and including a key identification (ID) indication in a BA control or BAR control field for the BA and BAR.
Example 32 may include the apparatus of example 31 and/or some other example herein, further comprising constructing Additional Authenticated Data (AAD) for the BA and BAR, including incorporating a Frame Control (FC) field of the BA and BAR with specific subfields modifications, and including a receiving station address (RA), and a transmitting station address (TA).
Example 33 may include the apparatus of example 32 and/or some other example herein, wherein the specific subfields modifications in the FC field include masking out the Retry, Power Management, and More Data subfields.
Example 34 may include the apparatus of example 31 and/or some other example herein, further comprising truncating the size of the MIC to 8 bytes if the original size of the MIC may be larger than 8 bytes.
Example 35 may include the apparatus of example 31 and/or some other example herein, further comprising using the same key for individually addressed and group addressed frame protection as used for Trigger frame protection.
Example 36 may include the apparatus of example 31 and/or some other example herein, further comprising utilizing the same replay counter as used for Trigger frame protection for both individually addressed and group addressed frames.
Example 37 may include the apparatus of example 31 and/or some other example herein, wherein the GMAC-256 may be mandated for use in all variants of the BA and BAR where an integrity protocol may be applied.
Example 38 may include the apparatus of example 31 and/or some other example herein, wherein the PN and MIC are included for both protected BA and BAR right before the FCS is checked by a receiver.
Example 39 may include the apparatus of example 31 and/or some other example herein, wherein for Multi-STA BA, a per AID-TID info subfield with special AID may be used to include the PN and MIC.
Example 40 may include the apparatus of example 31 and/or some other example herein, further comprising: encrypt one or more control frames using authentication encryption protocols including Galois/counter mode protocol (GCMP) with 256-bit key; and setting a protected frame subfield field in a frame control field to be equal to “1.”

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
utilize a Galois Message Authentication Code with a 256-bit key (GMAC-256) as an integrity protocol for block acknowledgment (BA) and block acknowledgment request (BAR);
generate a packet number (PN) and Message Integrity Code (MIC) using GMAC-256 for integrity design in the BA and BAR; and
include a key identification (ID) indication in a BA control or BAR control field for the BA and BAR.

2. The device of claim 1, wherein the processing circuitry is further configured to construct Additional Authenticated Data (AAD) for the BA and BAR, including incorporating a Frame Control (FC) field of the BA and BAR with specific subfields modifications, and including a receiving station address (RA), and a transmitting station address (TA).

3. The device of claim 2, wherein the specific subfields modifications in the FC field include masking out the Retry, Power Management, and More Data subfields.

4. The device of claim 1, wherein the processing circuitry is further configured to truncate the size of the MIC to 8 bytes if the original size of the MIC is larger than 8 bytes.

5. The device of claim 1, wherein the processing circuitry is further configured to use the same key for individually addressed and group addressed frame protection as used for Trigger frame protection.

6. The device of claim 1, wherein the processing circuitry is further configured to utilize the same replay counter as used for Trigger frame protection for both individually addressed and group addressed frames.

7. The device of claim 1, wherein the GMAC-256 is mandated for use in all variants of the BA and BAR where an integrity protocol is applied.

8. The device of claim 1, wherein the PN and MIC are included for both protected BA and BAR right before the FCS is checked by a receiver.

9. The device of claim 1, wherein for Multi-STA BA, a per AID-TID info subfield with special AID is used to include the PN and MIC.

10. The device of claim 1, wherein the processing circuitry is further configured to:
encrypt one or more control frames using authentication encryption protocols including Galois/counter mode protocol (GCMP) with 256-bit key; and
set a protected frame subfield field in a frame control field to be equal to “1.”

11. A non-transitory computer-readable medium storing computer-executable instructions which when executed by one or more processors result in performing operations comprising:
utilizing a Galois Message Authentication Code with a 256-bit key (GMAC-256) as an integrity protocol for block acknowledgment (BA) and block acknowledgment request (BAR);
generating a packet number (PN) and Message Integrity Code (MIC) using GMAC-256 for integrity design in the BA and BAR; and
including a key identification (ID) indication in a BA control or BAR control field for the BA and BAR.

12. The non-transitory computer-readable medium of claim 11, wherein the operations further comprise constructing Additional Authenticated Data (AAD) for the BA and BAR, including incorporating a Frame Control (FC) field of the BA and BAR with specific subfields modifications, and including a receiving station address (RA), and a transmitting station address (TA).

13. The non-transitory computer-readable medium of claim 12, wherein the specific subfields modifications in the FC field include masking out the Retry, Power Management, and More Data subfields.

14. The non-transitory computer-readable medium of claim 11, wherein the operations further comprise truncating the size of the MIC to 8 bytes if the original size of the MIC is larger than 8 bytes.

15. The non-transitory computer-readable medium of claim 11, wherein the operations further comprise using the same key for individually addressed and group addressed frame protection as used for Trigger frame protection.

16. The non-transitory computer-readable medium of claim 11, wherein the operations further comprise utilizing the same replay counter as used for Trigger frame protection for both individually addressed and group addressed frames.

17. The non-transitory computer-readable medium of claim 11, wherein the GMAC-256 is mandated for use in all variants of the BA and BAR where an integrity protocol is applied.

18. The non-transitory computer-readable medium of claim 11, wherein the PN and MIC are included for both protected BA and BAR right before the FCS is checked by a receiver.

19. The non-transitory computer-readable medium of claim 11, wherein the operations further comprise:
encrypt one or more control frames using authentication encryption protocols including Galois/counter mode protocol (GCMP) with 256-bit key; and
setting a protected frame subfield field in a frame control field to be equal to “1.”

20. A method comprising:
utilizing a Galois Message Authentication Code with a 256-bit key (GMAC-256) as an integrity protocol for block acknowledgment (BA) and block acknowledgment request (BAR);
generating a packet number (PN) and Message Integrity Code (MIC) using GMAC-256 for integrity design in the BA and BAR; and
including a key identification (ID) indication in a BA control or BAR control field for the BA and BAR.
